(19) United States
(12) Patent Application Publication
(10) Pub. No.: US 2026/0336213 A1
(43) Pub. Date: Oct. 29, 2026

(54) ADDITIVE MANUFACTURING OF THERMOSETTING POLYMERS USING THERMAL LASER CURING

(71) Applicant: Phase, Inc., Cornelius, NC (US)

(72) Inventors: Jeffrey Patrick SCHULTZ, Huntersville, NC (US); Simeon BROWN, Mooresville, NC (US)

(73) Assignee: Phase, Inc., Cornelius, NC (US)

(21) Appl. No.: 19/107,987

(22) PCT Filed: Aug. 29, 2023
(86) PCT No.: PCT/US2023/073060

§ 371 Date: Feb. 28, 2025

Related U.S. Application Data
(63) Continuation-in-part of application No. PCT/US2023/065371, filed on Apr. 5, 2023.
(60) Provisional application No. 63/374,538, filed on Sep. 3, 2022.

(51) Int. Cl. B29C 64/268; B29C 64/135; B29C 64/214; B33Y 10/00; B33Y 70/00

(52) U.S. Cl. CPC B29C 64/268; B29C 64/135; B29C 64/214; B33Y 10/00; B33Y 70/00

(57) ABSTRACT

Disclosed are methods and devices to build 3-D cured thermoset polymers with lasers. These devices do not need any UV additive and can be made without using a vat or spin coating techniques. The method relies upon using a tilted sharp blade as the re-coater and the translation of the uncured material in the Z direction for relatively tall parts.

### CROSS REFERENCES AND PRIORITIES

This application claims priority from U.S. Provisional Patent Application No. 63/374,538 filed on 3 Sept 2022 and PCT/US 2023/065371, filed on 5 Apr. 2023, the teachings of both of which are incorporated by reference herein in their entirety.

### UNITED STATES GOVERNMENT RIGHTS

THIS INVENTION WAS MADE WITH GOVERNMENT SUPPORT UNDER 1R43TR003968-01 AWARDED BY THE NATIONAL INSTITUTES OF HEALTH. THE GOVERNMENT HAS CERTAIN RIGHTS IN THE INVENTION.

### BACKGROUND

Additive Manufacturing (AM), also known as three-dimensional (3D) printing has received attention for printing optics and microfluidic structures.

Much of this work has focused on polydimethylsiloxane (PDMS). It is known as having unusual rheological properties, optically clear, non-toxic, and non-flammable.

A review of such processes and their limitations are provided in United States Application No. 2020/0030879 to Liang, et al., titled LASER-ASSISTED ADITIVE MANUFACTURING OF OPTICS USING HEAT CURABLE MATERIALS, the teaching of which are incorporated by reference herein in their entirety.

Many processes use ultraviolet light to cure or polymerize the components of a mixture. According to Liang, the UV curing leaves the article yellowish.

UV curing is typically accomplished by initiating a reaction upon being exposed to UV light in the UVB (280-320 nm) or UVA (320-395 nm) spectra. PDMS does not absorb light in these ranges and therefore a UV absorbing additive is required. This adds another component to the PDMS part.

UV curing is considered the “go to” approach for manufacturing parts from PDMS. There is a large body of work trying to find ways to change the chemistry or accelerate the hardening of PDMS. However, these parts are considered inferior by the research community which wants the traditional PDMS with hardener to conduct its research. A need exists to make PDMS parts without the addition of more than one hardener.

Riahi, et al in their article titled “Fabrication of 3D microfluidic structure with direct selective laser baking of PDMS” used a CO₂ laser having a wavelength of 10.6 micrometer (10,600 nm) to cure a mixture of PolyDiMethyl Siloxane and a hardener in an additive manufacturing layer-by-layer process.

Riahi's process sequentially lowered the part into a vat of PDMS mixture with the PDMS and then recoated the PDMS across the top of the part to form the next layer which is then cured.

As shown in Riahi's FIG. 5, the re-coater is a typical industry re-coater which wipes the PDMS from the vat (PDMS Mixture). Because the part is lowered into the vat, the PDMS in the vat is slightly higher than the part due to the PDMS's viscosity and surface tension and the re-coater just slides across the part taking some of the slighter higher PDMS with it.

No microfluidic devices are demonstrated in Riahi. Riahi's images and micrographs show that what should be optically clear is not. The demonstration images have poor optical clarity, even opaque, and a significant number of large, trapped air bubbles or debris are visible.

These defects are likely due to degradation of the PDMS induced by excessive laser heating.

According to Riahi, the curing depth of PDMS with the laser was around 200 micrometers. This large curing depth is reportedly associated with the limited accuracy of the VAT POLYMERIZATION 3D printing techniques.

There exists therefore the need for a 3D printing process for heat curable resins of much thinner layers that does not rely upon a third component and do not rely upon a vat which has proven to have insufficient control for thin layer parts of less than 200 microns.

### SUMMARY

This specification discloses a method of additively manufacturing a heat cured article from a heat curable mixture. According to the specification the method comprises the steps of creating a puddle of the heat curable mixture at a position on a build stage, forming at least a portion of the puddle into a heat curable current layer L(n) having a layer thickness T(n), wherein forming comprises translating the heat curable mixture with a re-coater blade across the build stage for a first layer L(0) or translating the heat curable mixture with the re-coater blade across a preceding layer L(n−1) when there is already a first layer, curing at least a portion of the heat curable current layer by applying an incident electromagnetic radiation energy to at least a portion of the heat curable current layer and optionally leaving an uncured portion of the heat curable current layer, wherein the incident electromagnetic radiation energy has at least one wavelength (2) wherein the heat curable mixture transmits less than 50% of the incident electromagnetic radiation energy per micron of the heat curable mixture at the at least one wavelength.

The steps of creating a puddle, forming the puddle into a layer and curing the desired portions of the layer are repeated until the heat cured article is formed followed by removing the uncured portions from within and around the heat cured article.

It is further disclosed that the at least one wavelength is in a range of 9.2 to 9.4 micrometers or in a range of 190 to 275 nanometers.

The specification teaches that the heat curable mixture comprises PDMS. It also teaches that the heat curable mixture may comprises a PDMS weight percent and a hardener weight percent totaling 100 weight percent.

The specification further discloses the heat curable mixture transmits at least 90% of an energy at each wavelength per micron of heat curable mixture in a wavelength range of 280 to 395 nanometers.

The specification then teaches that the re-coater blade used in the method is a knife-edged blade which may have an edge apex thickness of less than 500 micrometers or less than 200 micrometers.

Also disclosed is that the re-coater blade is at a tilt angle of less than 90 degrees or within a range of 15 to 85 degrees, or within a range of 40 to 50 degrees. This specification also teaches a method of creating a heat curable layer L(n+1) having a thickness of T(n+1) of a heat curable mixture on a cured top layer L(n) of a heat cured part located on a build stage with the heat cured part having a heat cured part height above the build stage.

The specification teaches that the method comprises placing a puddle of a heat curable mixture on the build stage having a puddle height above the build stage at 5 seconds after being placed on the build stage, wherein the puddle height is less than the heat cured part height, translating the puddle in an X direction toward the heat cured part with a re-coater blade having a re-coater blade end until a portion of the heat curable mixture is forced in a Z direction and is above, and on top of, the cured top layer; translating the puddle in the Z direction with the re-coater blade so that the re-coater blade end is above the cured top layer L(n) so that a gap between the re-coater blade and the cured top layer is equal to the thickness T(n+1) of the heat curable layer L(n+1), and then forming the heat curable layer L(n+1) on the cured top layer, by translating the puddle in the X direction on the cured top layer.

It is disclosed that the heat curable mixture of this method comprises uncured PDMS.

It is also disclosed that the heat curable mixture may comprise a weight percent of PDMS and a weight percent of hardener totaling 100 weight percent.

It is further disclosed that the heat curable mixture used in the method will transmit at least 90% of an energy at each wavelength per micron of heat curable mixture in a wavelength range of 280 to 395 nanometers.

The method further uses a knife-edged blade having an edge apex thickness of less than 500 micrometers or less than 200 micrometers.

It is also disclosed that the re-coater blade is at a tilt angle of less than 90 degrees or in a range of 15 to 85 degrees, or in a range of 40 to 50 degrees.

A microfluidic device comprising a plurality of layers of a cured PDMS, a lower channel section having a lower channel, with the lower channel having at least a first lower channel port and a second lower channel port, an upper channel section located above the lower channel section having an upper channel, with the upper channel having at least a first upper channel port and a second upper channel port, wherein at least portion of the upper channel crosses over the lower channel with a membrane separating the upper channel and lower channel, and each of the first upper channel port, the second upper channel port, the first lower channel port and the second lower channel port have an electrode formed with the cured PDMS and connected with the first channel or the second channel is also disclosed.

This microfluidic device will have at least one electrode is at a bottom of a port.

At least one electrode may comprise Indium Tin Oxide (ITO). These electrodes may be attached to contact pads.

The microfluidic device can transmit at least 90% of an energy at each wavelength per micron of the microfluidic device in a wavelength range of 280 to 395 nanometers.

The upper channel and/or the lower channel can have at least one dimension less than 150 micrometers in the Z direction, the X direction or the Y direction.

### BRIEF DESCRIPTION OF FIGURES

FIG. 1 is a perspective view of a cured multi-layered PDMS microfluidic device with a channel made by this process.

FIG. 2 is a 3 dimensional view of a cured multi-layered PDMS microfluidic device made according to the invented method.

FIG. 3A is a cured multi-layered PDMS device made according to this invention.

FIG. 3B is a cross-sectional view of a cured multi-layered PDMS device made according to this invention.

FIG. 4 is a top view of a cured multi-layered PDMS device made according to this invention and measurements of its internal features.

FIG. 5 is a side view of the system used to practice the invention.

FIG. 6A is a side view of the re-coater assembly.

FIG. 6B is a perspective view of the re-coater assembly.

FIG. 6C is a schematic side view of the invented re-coater.

FIG. 7A is a side view of the re-coater blade starting to form a layer of uncured PDMS.

FIG. 7B is a side view of the re-coater blade after forming the first layer of uncured PDMS.

FIG. 8A is a side view of the re-coater blade starting to form a layer of uncured PDMS when the height of the part is greater than the height of the PDMS puddle.

FIG. 8B is a side view of the re-coater blade just prior to forming a layer of uncured PDMS on top of a part whose height in the Z direction is greater than the height of the uncured PDMS puddle.

FIG. 8C is a side view of the re-coater lifting the uncured PDMS puddle to the top layer of the part when the height of the part is greater than the height of the uncured PDMS puddle.

FIG. 8D is a side view of the re-coater blade starting to thin the puddle of uncured PDMS on the top layer of the part and form the next layer.

FIG. 8E is a side view of the re-coater blade and slide stage after forming the layer of uncured PDMS.

FIG. 9 is a graph of the relative transmittance of light per micrometer of uncured PDMS.

### DETAILED DESCRIPTION

It is important to understand that unless there is a measure bar on the figure, the figures are not to scale.

The method and devices disclosed herein are based upon the research done attempting to print a microfluidic part by sequentially heat curing layers of PDMS (polydimethylsiloxane) and a hardener without the use of electromagnetic radiation absorbers such as UV activators or other curing agents.

One brand of this PDMS is known as Sylgard 184, available from DOW Chemical, Midland, Michigan, USA.

The original project started out trying to find a laser to cut cured PDMS into a shape. A laser having a 10.6 micrometer wavelength was evaluated and it was incapable of cutting the cured PDMS. It appeared as if the glass slide upon which the part was located was locally shattering. A 1.2 micrometer laser was evaluated. It showed slightly better results, but the slide still seemed to heat before the cured PDMS. A 9.3 micrometer laser was evaluated and the ability to cut the cured PDMS was demonstrated. Seeing the ability to cut the cured PDMS led to the thought that the 9.3 micrometer wavelength laser might work for curing the uncured PDMS as well.

Based on these results it was surprisingly discovered that a much thinner layer could be cured (7 micron) when a 9.3 micrometer wavelength laser was used as opposed to the 200-400 micrometer layer of the 10.6 micrometer wavelength laser used in the prior art.

Both lasers were CO₂ lasers.

It was discovered that the transmission of electromagnetic radiation through PDMS at the wavelength of 9.3 micrometers was much less than the transmission at 10.6 micrometers. Because transmission is relative to thickness, it is always normalized to a thickness which this application choses to be 1 micrometer for ease of calculations.

While not to be bound by any theory it is believed that the high transmittance at 10.6 micrometers, as opposed to a low transmission and high absorption at 9.3 micrometers, explains why the cure depth at 10.6 micrometers is as deep as 200-400 micrometers as noted in Riahi. In other words, it is believed that the electromagnetic energy at 10.6 micrometers is simply just passing through the PDMS before the energy can cure the PDMS. The top of the layer is just not capable of absorbing enough of the energy at 10.6 micrometers to cure the material.

Once the relationship between transmittance per micrometer and the wavelength of electromagnetic radiation was made, transmittance per micrometer of the heat curable mixture became a control parameter in selecting the wavelengths of the energy source and the associated power. Less transmittance (more absorption), means a faster cure for thinner parts, thus enabling smaller layers, smaller channels, and far better microfluidic structures.

Because speed of curing is essential in printing the part, the less the transmission per micrometer, the quicker the part can be built and subsequently cleaned of the uncured PDMS. As a corollary, a slow build/slow cure will allow the PDMS which is not supposed to be cured to cure due to the heat energy in the room at standard pressure and temperature.

The energy source applied to the part is not limited to a single wavelength source but could be a range of wavelengths or perhaps two or more discrete wavelengths striking the surface, just so long as the heat curable mixture has a transmission of at least one of the incident wavelengths per micrometer of less than 40%. It is preferred that the transmission of the incident wavelength per micrometer of the heat curable mixture be less than 55%, with less than 50% being more preferred, with less than 45% being even more preferred, with less than 40% being even more preferred with less than 35% being most preferred.

Alternatively, this could be expressed as the cured part of the heat curable mixture absorbing 1-the percent transmission. In other words, the cured part or the heat curable mixture absorbs more than 60% of the energy of at least one of the incident wavelengths per micrometer of the respective cured part or heat curable mixture. It is believed that the absorption at that wavelength per micrometer of the heat curable mixture or cured part should be more than 45%, with more than 50% being more preferred, with more than 55% being even more preferred, with more than 60% being even more preferred with more than 65% being most preferred.

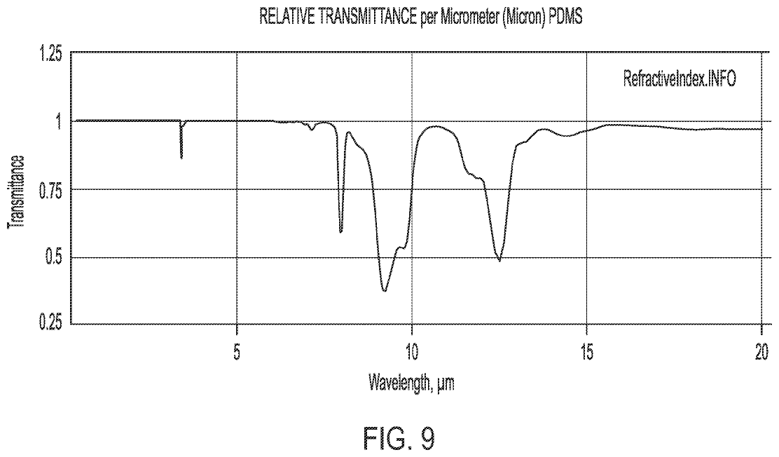

The data of Transmission vs wavelength for PDMS can be found at the website https://refractiveindex. info/? shelf=organic&book=polydimethylsiloxane&page=Zhang-10-1 which is reproduced in FIG. 9.

As shown in FIG. 9 there are 5 Transmission peaks with maxima at 86% @3.4 micrometer, 60% @8 micrometer, 37% @9.3 micrometer, and 48% @12.5 micrometer. As can be seen from FIG. 9 the rest of spectra exhibits more than 75% Transmission, and in many cases almost 100% Transmission.

Based upon the experiments coupled with FIG. 9, it was proven that one wavelength range of electromagnetic radiation in which to cure the heat curable mixture is 9.2 to 9.4 micrometers.

Another wavelength range of electromagnetic radiation in which to cure the heat curable mixture is the UVC range which is in the range of 190 nm to less than 280 nm, more preferably 190 nm to 275 nm, and even more preferably 190 nm to 250 nm or 190 nm to 235 nm

This % Transmission per micrometer of PDMS parameter is useful in both vat printing and vat-less printing as described below.

The PDMS of this invention can now be free, or void, of added UV absorber(s), heat up additives, or other agents overcoming the inherent difficulties of current curing techniques. Put another way, the heat curable mixture can be considered to have an amount of PDMS and an amount of hardener, which on a weight basis add up to 100 weight percent of the heat curable mixture. The hardener could itself be a mixture blended with the PDMS. However, the heat curable mixture should be void of any substance that does not play a role in the curing or hardening of the PDMS.

Alternatively, because there are no UV absorbers in the heat curable mixture or the cured PDMS, (i. e the heat curable mixture or the cured part are void of added UV absorbers) the heat curable mixture can have a transmission per micrometer of greater than 90% in the UVA and UVB spectrum (280 nm to 395 nm). When cured, the cured PDMS in the part can also have a transmission per micrometer greater than 50% in the UVA and UVB spectra, with 60% more preferred, 75% even more preferred and 90% most preferred.

Alternatively, this could be expressed as the cured part of heat curable mixture absorbing (1-the percent transmission). In other words, the cured part or the heat curable mixture absorbs less than 50% of the energy of at least one of the incident wavelengths per micrometer of the respective cured part or heat curable mixture. It is believed that the absorption at that wavelength per micrometer of the heat curable mixture or cured part should be less than 50%, with less than 40% being more preferred, with less than 25% being even more preferred, with less than 10% being even more preferred.

The energy source (laser) is then turned on to cure at least a portion of the layer. In the case of a focused source or spot, the spot is scanned over the surface of the image for the appropriate amount of time. The focus spot in these experiments was 80 micrometers. The energy is directed only to those portions that are to be cured, it is not directed to those portions which are to remain uncured, such as the inside of a channel. The uncured portion is washed away from the part later.

It was discovered that the initial layers forming the base layer had to be at least 100 micrometers thick before building the part. It was discovered that the part would not stay adhered to the glass stage if the base layer comprised of multiple layers was less than 100 micrometers thick.

It is important to note the build stage is the component upon which the part is to be built. The apparatus stage is the component of the device which is acted upon to translate the part. This is because there is nothing else on the apparatus. In most cases, a glass slide will be placed upon the apparatus stage with the slide being the build stage, or glass stage.

The layered PDMS article is created by curing a PDMS base layer, L(0) onto the build stage. Another layer of heat curable mixture is formed on top of the previous cured layer, and then cured. Thus, the name “layer-by-layer” building.

In this application the current layer being spread and subsequently cured is the current layer L(n). The layer immediately previous to the current layer is L(n−1).

The first layer in contact with the build stage is layer L(0).

Each layer “n” will have a layer thickness, which is denoted T(n).

These application of the uncured layers upon a cured PDMS layer is done by a process known as re-coating which places another coat or layer (n) upon the previous layer (n−1). The re-coating is done by a re-coater.

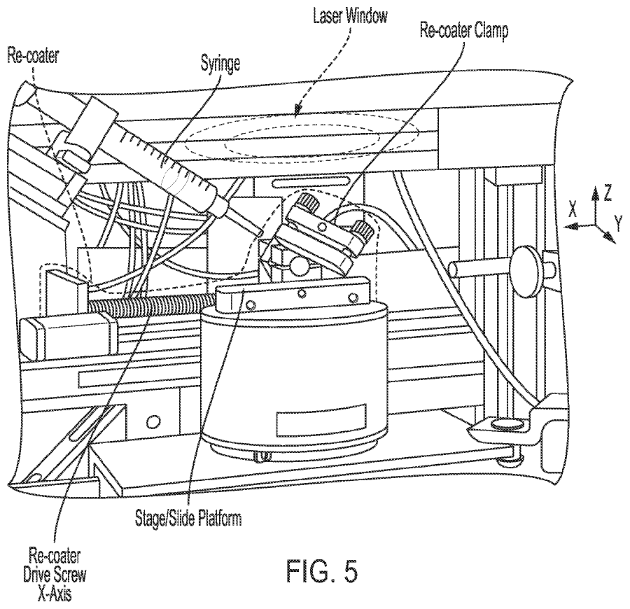

A typical prior art re-coater is shown in FIG. 5 of Riahi which depicts a rotating paddle, or rotating blade, which pulls the heat curable material from the vat over the surface of the part after the build stage is lowered into the vat.

In the vat process such as that disclosed in Riahi, the part is lowered into the liquid uncured PDMS so that the level of the PDMS is at, or slightly higher than the top cured layer (n). The re-coater than swipes a portion of the liquid PDMS to place a layer (n) of uncured PDMS across the top cured layer, which is now layer (n−1).

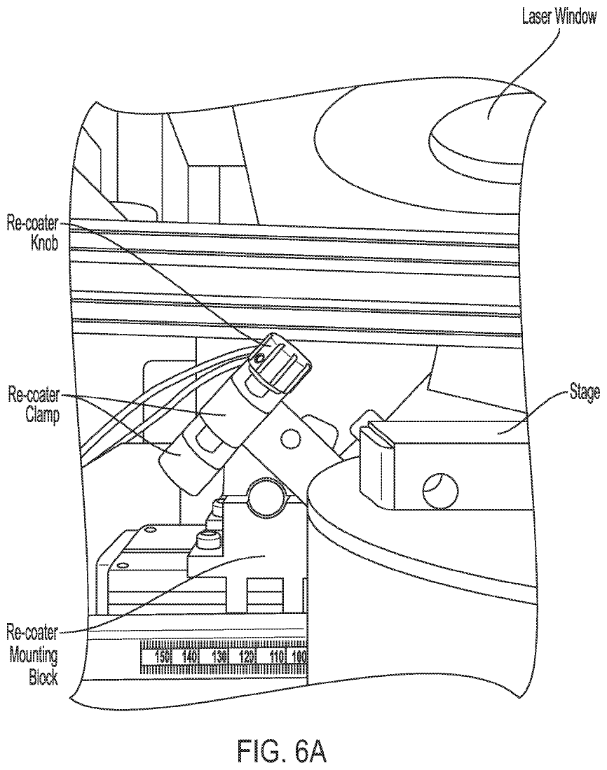

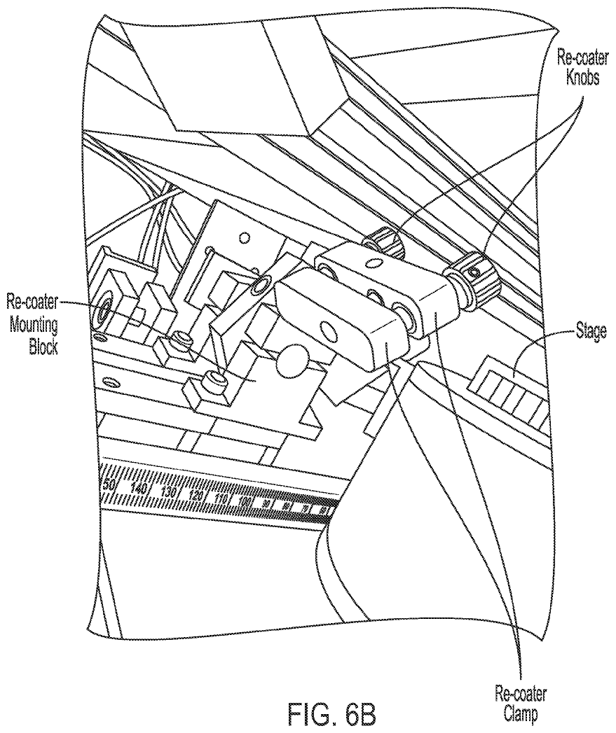

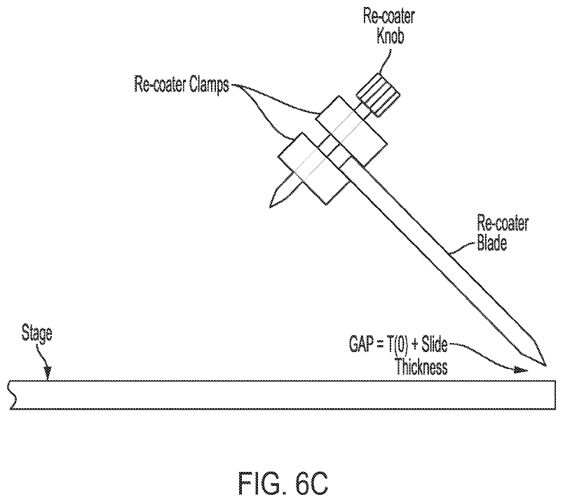

The vat-less assembly used in this process is shown in FIGS. 6A, 6B, and 6C and described in detail below.

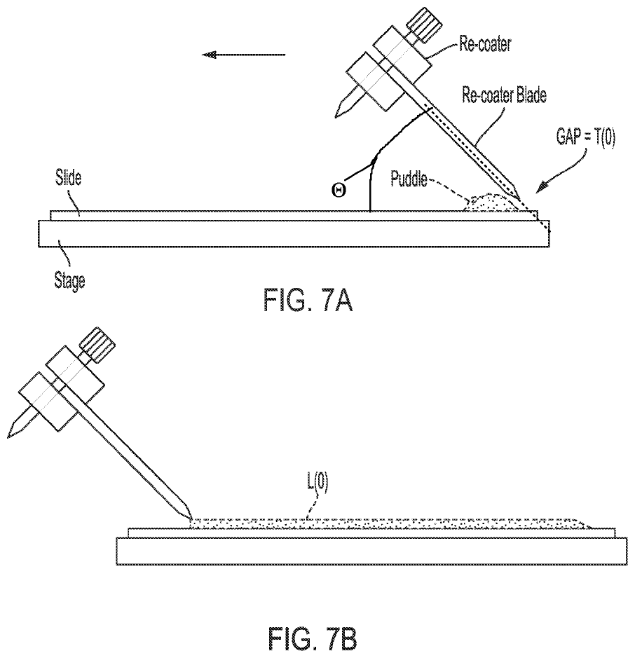

In the vat-less layer-by-layer printing technique an amount of heat curable mixture is placed upon a horizontal (X-Y) stage. (FIG. 7A) The amount is preferably less than the amount that will flow on its own accord or that will flow across the build stage as the mass is greater than the surface tension of the mixture. Typically, the heat curable mixture is placed upon the build stage and referred to as a puddle, although it may also be called a drop or bead.

It is also conceived that the heat curable substance can be deposited on the top of the part itself and then thinned across the top to form the current layer.

This amount of heat curable mixture is then spread into a thin layer of thickness T(n), which in this case was as small as 7 micrometers.

Once the first layer, L(0) is cured, the build stage and/or the re-coater are indexed in the Z direction for placement of the next amount of uncured PDMS.

The experiments focused on placing a bead/puddle/drop of uncured PDMS on the build stage and creating the first and subsequent layers without using a vat, i.e. a vat-less process and without spinning the part.

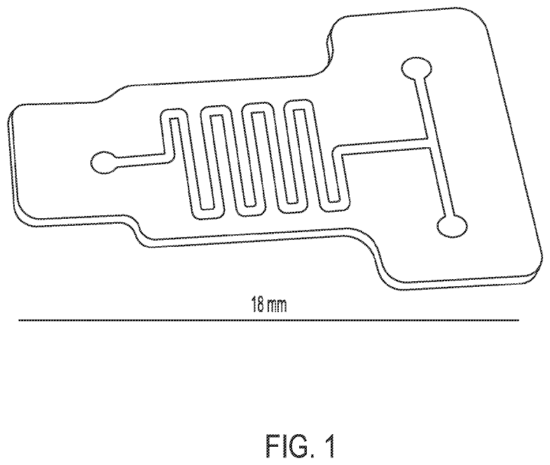

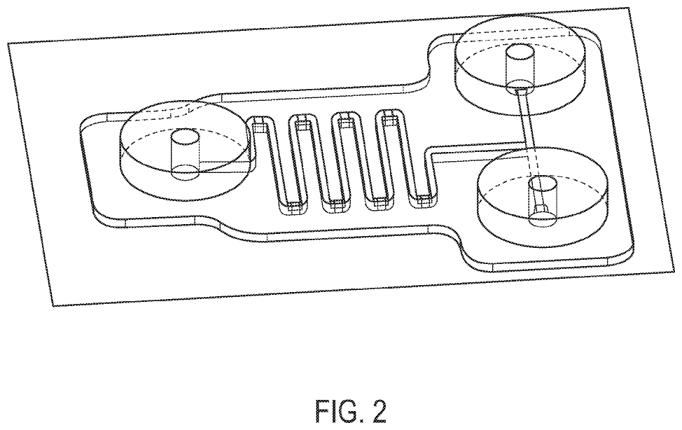

The part is washed after the multi-layered part is built with the specified areas cured. The wash removes the uncured PDMS from the part, such as the uncured portions in the channels such as those shown in FIGS. 1 to 4.

The equipment used in these experiments had a vertical translation stage and a stepper to raise or lower the stage under 1 micrometer, allowing the achievement of layers of less than 1 micrometer thick. This is the stage/slide platform in FIG. 5, and the stage in FIGS. 6A and 6B.

Horizontal translation of the puddle was accomplished by moving the re-coater blade in the X direction towards the part.

Translation in the Z direction was done by lowering the build stage.

It is important to understand that translation of the puddle along the X axis is always relative to the part. It does not necessarily mean that the re-coater moves along the X axis as the build stage could move along the X axis which moves the part and brings the re-coater blade closer to the part. If speed is a concern, both the re-coater blade and the stage could move.

The same is true for the Z and Y axes. Translating the puddle in the +Z axis means the that the re-coater blade could move, the stage could move, or both could move so that the puddle translates up in the Z direction relative to the part. I.E., the re-coater blade could be lifted in the +Z direction or the build stage lowered in the −Z direction. (As the re-coater blade cannot be below the stage, a negative distance between the stage and re-coater blade is not relevant).

The re-coater, its drive, and clamps to hold the re-coater blade are shown in FIG. 5. FIG. 5 also shows the dispensing syringe and laser window.

The microfluidic PDMS devices in this specification were constructed layer-by-layer, on a plasma activated microscope slide (the build stage), through successive laser curing of thin layers of liquid PDMS to the previous device layer. The components are shown in FIGS. 5, 6A and 6B. Liquid PDMS premixed with the curing agent is dispensed by the translating PDMS syringe pump on the slide (stage) and the tilted-knife-re-coater (knife blade) distributes uniform layers of liquid PDMS over the previous layer with 7 micrometers being a typical layer thickness (T).

A Keyence MLZ 9650-T 9.3 micrometer CO₂ laser lithography unit was used to selectively cure the PDMS. The system has negative defocusing of the laser so that the focal point of the laser can be inside the layer or article.

Exemplary process parameters were laser power 5-6W, scan speed of 1 m/s, scan spacing 5 micrometer and defocusing distance of −2 mm. These operating parameters and how to manipulate them are well known in the art.

It was discovered that in the vat-less process without spinning, a tilted knife edge, like a razor blade, was needed to achieve the desired thin layers and limit peeling of the previous layer.

It was for this reason a razor blade with a sharp edge is preferred. Use of the tilted knife edge overcame the drawbacks of the conventional, traditional, vertical bar re-coater which is pulled across the top of the part.

These drawbacks were the adherence of the PDMS to the trailing edge of the re-coater which was deposited as part of the layer behind the re-coater causing the layer thickness to be greater than desired and of inconsistent thickness. Furthermore, the vertical edge of the vertical bar re-coater often peeled the edges of the cured PDMS layer from the part.

The tilt angle (FIG. 7A) of the tilted knife-edge applies a downward force on the top of the puddle during translation and minimizes edge peeling because the re-coater blade has a sharp trailing edge. As the puddle is only translated in one direction there is no opportunity for the uncured PDMS to adhere to the back of the re-coater blade.

The original experiments used a syringe separated from the re-coater blade to deposit the PDMS puddle on the slide which is mounted on the stage. Subsequent experiments had the syringe attached to the re-coater blade to ensure the puddle placement on the build stage was precise from layer to layer.

The re-coater blade was then translated towards the part in the X axis creating the top layer, L(n), which is then cured. Once started across the slide, the puddle would create a wave like form up the re-coater blade and flow across the re-coater blade width (Y direction) as the puddle was pulled across the slide to the part.

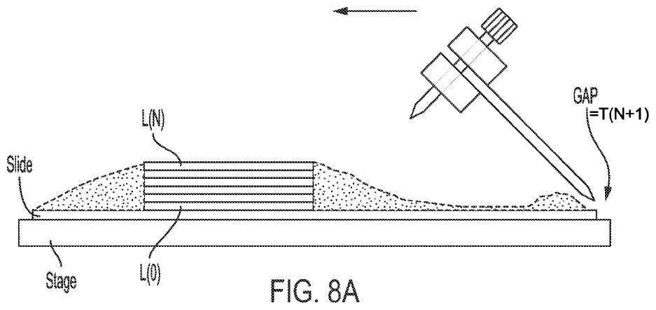

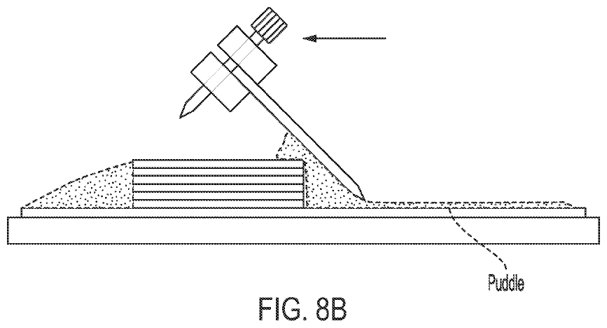

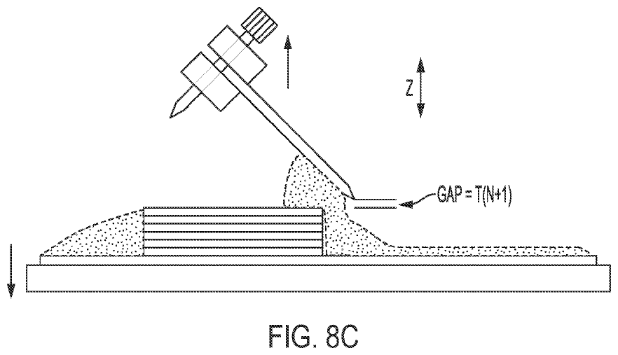

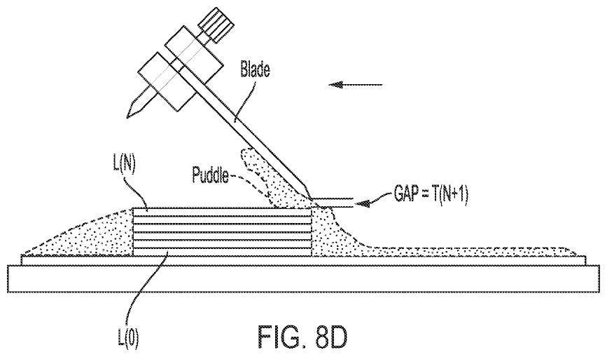

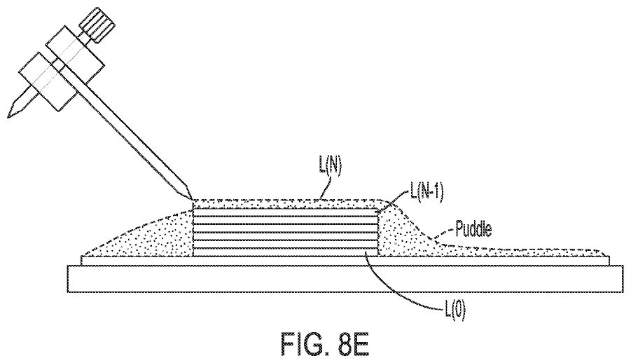

As shown in FIG. 7A there is a gap between the end of the re-coater blade (the tip) and the build slide equal to the thickness of layer. In the case of the first layer, the gap equals T(0) (FIG. 7A). Subsequent gaps are the thickness of the next layer to be placed T(n+1) (FIG. 8A).

The re-coater blade of the invented process was a steel razor blade with a precision edge which means that the re-coater blade edge is sharper than other razor blades for fine, precise cuts. The blade used was an American Line (American Safety Razor Company, Verona, VA, USA) blade part No. 66-0362 (Accutec Pro Extra Keen Single Edge Blade), 0.009″/0.2286 mm.

Material of construction of the re-coater blade seemed to make little difference. Teflon® coating, ceramic and 3-D built plastic blades were tried. While they performed differently, none seemed better than the other.

The Teflon® coated blade did display some of the PDMS puddle seeping under the bleed and squeezing out the side opposite the part.

As mentioned previously, subsequent modifications attached the PDMS dispensing mechanism (the syringe) to the re-coater blade so that the re-coater blade was accurately positioned before the heat curable PDMS was deposited.

The sharpness of a blade is well known in the art and is measured by edge apex thickness. The edge apex radius is half the value of the of edge apex thickness. For example, a 50 nm apex radius, which is 100 nm or 0.1 micron edge apex thickness.

The terms Razor sharp, Wickedly sharp and Crazy sharp are well known categorization of sharpness corresponding to edge apex thicknesses.

Wickedly sharp is a preferred sharpness which is less than an edge apex thickness of less 0.3 micron. More preferable is Crazy sharp which is an edge apex thickness of less than 0.2 micron. Insane sharp will cut a free hanging hair and is preferable in the range of 0.1 to 0.15 micron. Razor sharp which splits hair are those edge apex thicknesses less than or equal to 0.1 micron. A blade sharper than Razor sharp, which can shave hair being most preferred and the edge apex thickness is less than 0.05 micron.

Alternatively, it can be expressed that the edge apex thickness be in a range selected from the group consisting of greater than 0.10 micron to less than 0.5 micron, to less than 0.3 micron, to less than 0.2 micron, to less than 0.15 micron. Other limits are, less than or equal to 0.1 micron and less than 0.05 micron.

The tilted knife edge re-coater having an edge apex thickness will be at a tilt angle relative to the plane formed by the X-Y axis. The X-Y axis should be parallel with the build stage plane and perpendicular to the Z axis.

As shown in FIG. 7A, the tilt angle, O, is the angle formed by a line bisecting the blade and intersecting an X-Y plane in the −Z direction from the blade. Preferably the tilt angle is less than 90 degrees. As shown in FIG. 7A, the re-coater blade is at a tilt angle of approximately 45 degrees. The tilt angle in the range of 15 to 85 degrees is also conceived, or 45 degrees +/−15 degrees is also preferred.

It was discovered that once the top layer of the heat cured part was higher (greater) in the Z direction than the heat curable puddle of PDMS at 5 seconds after being placed on the build stage, the liquid heat curable mixture (PDMS with hardener) would flow off the part and away from the re-coater blade as the puddle was translated across the build stage resulting in a non-uniform liquid layer thickness. Typically this occurred when the cured part height above the build stage was 1 mm or when the ratio of the puddle height at 5 seconds after being placed on the build stage from the build stage to the cured part height from the build stage was 0.75.

To overcome this problem a conformal re-coating strategy was discovered as depicted in FIGS. 8A to 8E.

In the conformal re-coating strategy the puddle is translated in the Z direction as well as the X direction. (FIG. 8C).

The conformal re-coating process begins with placing a puddle of a heat curable mixture of PDMS on the build stage between the part and the re-coater blade in the X direction. As shown in FIG. 8A, there are “ramps” of uncured PDMS (area with dots) on either side of the part. The ramp on the right side of the part is what is left over after the layer portion of the uncured PDMS is separated from the puddle. The ramp on the left is the excess uncured PDMS that flows down the side of the part after the layer is formed.

As shown in FIG. 8A, the puddle height is less than the cured part height.

As shown in FIG. 8B, the puddle of curable PDMS is translated along the X axis towards the part with the force from the re-coater spreading the puddle across the re-coater blade (Y axis) and pushing the puddle up the re-coater blade (Z axis) from the slide.

During this initial translation step, the translating puddle approaches the part and is then forced up against the part and up the re-coated blade (FIG. 8B). This can be done by moving the re-coater blade, the build stage or both.

The titled re-coater blade in the examples moved at 20 mm/sec. Like the thinning of caulk, translating the puddle towards the part with the re-coater blade pushes the puddle up the re-coater blade until a portion of the puddle is forced over, and on to, the top layer of the part as shown in FIG. 8B.

As shown in FIG. 8C, the puddle is then translated in the +Z direction, i.e. lifted above the top layer of the part. This can be done by raising the re-coater blade in the +Z direction or lowering the build stage in the −Z direction, moving both, until the distance between the build stage to the re-coater blade end its tip equals the sum of the cured thicknesses (height of the cured part in the Z direction) plus the thickness of the next layer, L(n+1), of heat curable PDMS to be layered on top of part.

As shown in FIG. 8C, the re-coater blade is translated to a height in the Z direction where the distance between the end of the re-coater blade at its tip and the slide equals the height of the cured PDMS part from the build slide along the Z axis, plus the thickness of the layer of heat curable PDMS to be placed on the part. This distance between the top layer and the slide is the thickness (T(n+1) of the layer to be formed (L(n+1) as shown in FIG. 8C.

This can be done by translating the re-coater blade along the Z axis which means either raising the re-coater blade along the Z axis, lowering the stage along the Z axis, or combination of both.

The puddle is then translated in the X direction across the cured top layer of the part (FIG. 8D, L(n)) forming a layer of heat curable PDMS (L(n+1)). Again, this translation can be done moving the re-coater blade or the build stage, or both. Once that layer is completed, the layer becomes new layer L(n). As shown in FIG. 8E the new layer is uncured, as evidenced by the dashed line and dots. The cured layer, shown with no dots, previously known as L(n) will become layer L(n−1) once the heat curable layer is cured. Layer “n” does not become layer n−1 until layer “n+1” is cured.

The speed of the re-coater blade at this point is typically less than the speed of the re-coater blade passing over the slide. In these experiments, the re-coater blade moved across the top of the part at a speed of 2 mm/sec. Care is taken to not move too fast as it will create wavy layers.

In FIG. 8E, the dashed line represents the new uncured layer, L(n) which has been translated onto the last cured layer, L(n−1).

Subsequent layers are made using this same conformational coating strategy. Once completed, the part is washed both inside and outside to remove the uncured material from in and around the part. The channels are formed when the uncured material is rinsed away leaving the channel.

Typical ranges for a layer of this invention are 5 micrometers to 200 micrometers, 5 micrometers to 150 micrometers, 5 micrometers to 100 micrometers, and 5 micrometers to 50 micrometers. Alternatively, this can be recited as the article comprises at least one layer having a thickness selected from the group consisting of 5 micrometers to 200 micrometers, 5 micrometers to 150 micrometers, 5 micrometers to 100 micrometers, and 5 micrometers to 50 micrometers.

The viscosity of the PDMS curable mixture is selected to enable the elimination of the PDMS vat using a conformal recoating technique where the re-coater blade follows the approximate upper −Z boundary of the X-Y profile of the build slide and the part moving the liquid up the side and the re-coating the top layer of article at each layer.

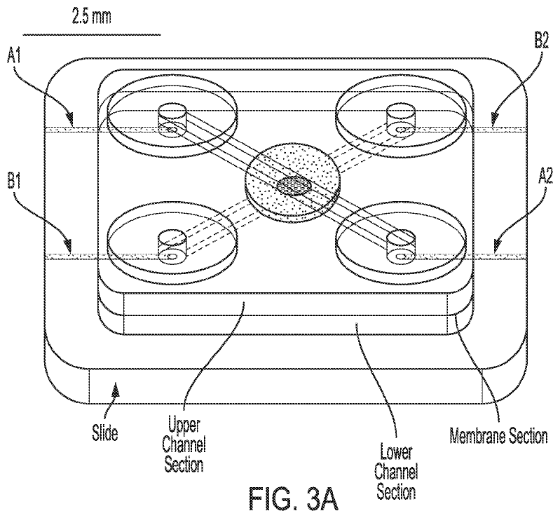

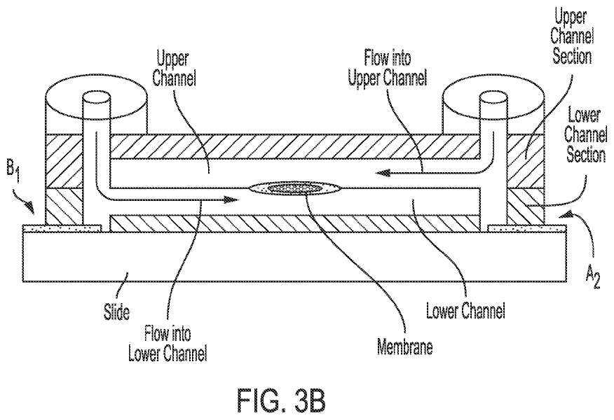

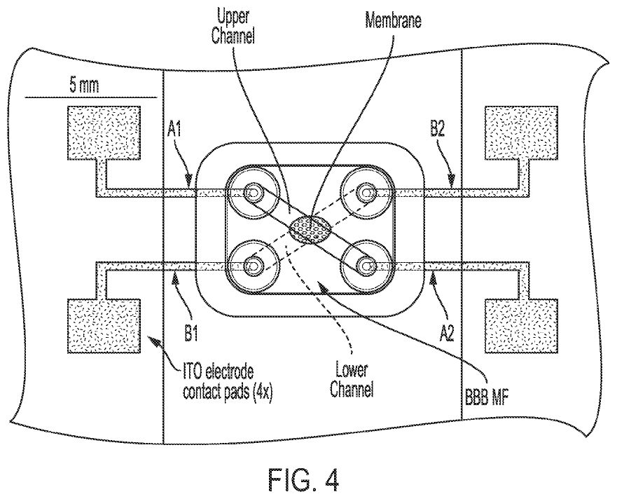

FIGS. 3A, 3B and 4 show various views of a microfluidic device made by the teachings of this specification.

As shown in FIG. 3A's perspective view, the cured microfluidic device may be built upon a slide, typically a glass slide, which is the build stage.

It should be noted that in FIGS. 3A, 3B, and 4 the lines of the individual build layers are not shown, and the microfluidic device is described in sections. While the Figures show the microfluidic device in sections, the section is made up of individual layers with at least some of them having thicknesses in the ranges disclosed in this specification.

There are two channels in this microfluidic device. There is an upper channel which crosses over a lower channel. In FIG. 3A, the upper channel is in the upper channel section and runs diagonally from upper left orientation to the lower right orientation. The lower channel is located in the lower channel section, below the upper channel section, and runs from the upper left orientation to the lower right orientation.

Each channel has two ports, one at each end. There is a first upper channel port associated with electrode A1, and a second upper channel port associated with electrode A2. There is a first lower channel port associated with electrode B1 and a second lower channel port associated with electrode B2. Each port is shown as a hollow cylinder with the port being open at the top of the microfluidic device and running to the respective electrode.

Electrodes A1, A2, B1 and B2 are indium tin oxide (ITO). They rest on the slide. They are placed there by affixing a layer of ITO on the slide and then ablating away the unwanted portions leaving the electrode. The microfluidic device is then built upon the slide.

As shown in FIG. 4, the electrode is attached to an ITO contact pad where the current is provided.

As shown in FIG. 3B, each electrode is located under the cured microfluidic device at the bottom of the respective port which is the open vertical cylinder directly above the electrode.

As shown in all three figures, there is a membrane separating the upper and lower channel. To produce this structure, the membrane is laid upon the top of the lower channel before the lid layer is formed. The lid layer is then drawn across the top of the channel membrane. The lid layer is then cured over the channel but only curing the portions of the channel which do not lay directly under the upper channel. That is, at least a portion of the lid layer where the channels coincide in the Z axis is not cured, leaving the membrane as the only separation between the channels at that spot. The next layer starts to form the walls of the upper channel.

When the microfluidic device is finished the upper and lower channel are rinsed to remove the uncured PDMS leaving two channels separated by the membrane where the upper channel crosses over the lower channel.

This device can be used to test and monitor many items. In this instance, the membrane used was to simulate the blood brain barrier (BBB), hence the name BBB MF (Blood Brain Barrier Microfluidic).

Many people try to insert needles into the channels to function as an electrode. This electrode formed with the cured PDMS and connected with the first channel or the second channel is a vast improvement in precision and stability of the electrode contact and is a far superior and more precise and accurate method to introduce current into the channel.

As shown in the FIG. 3A and FIG. 3B, the placement of the electrode at the bottom of the port ensures constant and the same contact area.

This device can be used to measure the properties of the barrier, such as conductivity.

As discussed above, this device could have channels with sides measuring any of the previously disclosed ranges, in particular sides in the range of 5 micron to 150 micron.

As stated previously, typical ranges for a layer of these processes and the layers of the devices described above are 5 micrometers to 200 micrometers, 5 micrometers to 150 micrometers, 5 micrometers to 100 micrometers, and 5 micrometers to 50 micrometers. Alternatively, this can be recited as the article comprises at least one layer having a thickness selected from the group consisting of 5 micrometers to 200 micrometers, 5 micrometers to 150 micrometers, 5 micrometers to 100 micrometers, and 5 micrometers to 50 micrometers.

These parts may only be 0.7 mm high, 700 microns high, or as high as 100 layers of 7 micron thick PDMS. The time to position the re-coater at translation speeds of 20 mm/sec and 2 mm/sec are almost negligible when the distance translated is only 0.7 mm.

1-27. (canceled)

28. A method of additively manufacturing a heat cured article from a heat curable mixture; the method comprising;
A. creating a puddle of the heat curable mixture at a position on a build stage;
B. forming at least a portion of the puddle into a heat curable current layer L(n) having a layer thickness T(n), wherein forming comprises translating the heat curable mixture with a re-coater blade across the build stage for a first layer L(0) or translating the heat curable mixture with the re-coater blade across a preceding layer L(n−1) when there is already a first layer;
C. curing at least a portion of the heat curable current layer by applying an incident electromagnetic radiation energy to at least a portion of the heat curable current layer and optionally leaving an uncured portion of the heat curable current layer, wherein the incident electromagnetic radiation energy has at least one wavelength (2) wherein a heat curable mixture transmits less than 50% of the incident electromagnetic radiation energy per micron of the heat curable mixture at the at least one wavelength;
D. repeating steps A to C until the heat cured article is formed;
E. removing the uncured portions from within and around the heat cured article.

29. The method of claim 28, wherein the at least one wavelength is in a range of 190 to 275 nanometers or in a range of 9.2 to 9.4 micrometers.

30. The method of claim 29, wherein the heat curable mixture comprises PDMS.

31. The method of claim 30, wherein the heat curable mixture comprises a PDMS weight percent and a hardener weight percent totaling 100 weight percent.

32. The method of claim 31, wherein the re-coater blade is a knife-edged blade having an edge apex thickness of less than 500 micrometers.

33. The method of claim 28, wherein the heat curable mixture comprises PDMS.

34. The method of claim 33, wherein the heat curable mixture comprises a PDMS weight percent and a hardener weight percent totaling 100 weight percent.

35. The method of claim 34, wherein the re-coater blade is a knife-edged blade having an edge apex thickness of less than 500 micrometers.

36. The method of claim 28, wherein the heat curable mixture comprises a PDMS weight percent and a hardener weight percent totaling 100 weight percent.

37. The method of claim 36, wherein the re-coater blade is a knife-edged blade having an edge apex thickness of less than 500 micrometers.

38. A method of creating a heat curable layer L(n+1) having a thickness T(n+1) of a heat curable mixture on a cured top layer L(n) of a heat cured part located on a build stage with the heat cured part having a heat cured part height above the build stage, the method comprising:
A. placing a puddle of a heat curable mixture on the build stage;
B. translating the puddle in an X direction toward the heat cured part with a re-coater blade having a re-coater blade end until a portion of the heat curable mixture is forced in a Z direction and is above, and on top of, the cured top layer;
C. translating the puddle in the Z direction with the re-coater blade so that the re-coater blade end at its tip is above the cured top layer L(n) so that a gap between the re-coater blade and the cured top layer is equal to the thickness T(n+1) of the heat curable layer L(n+1);
D. forming the heat curable layer L(n+1) on the cured top layer, by translating the puddle in the X direction on the cured top layer.

39. The method of claim 38, wherein the heat curable mixture comprises a weight percent of PDMS and a weight percent of hardener totaling 100 weight percent.

40. The method of claim 39, wherein the heat curable mixture can transmit at least 90% of an energy at each wavelength per micron of heat curable mixture in a wavelength range of 280 to 395 nanometers.

41. The method of claim 40, wherein the re-coater blade is a knife-edged blade having an edge apex thickness of less than 500 micrometers.

42. The method of claim 41, wherein the re-coater blade is at a tilt angle with an X-Y plane of less than 90 degrees.

43. The method of claim 38, wherein the heat curable mixture can transmit at least 90% of an energy at each wavelength per micron of heat curable mixture in a wavelength range of 280 to 395 nanometers.

44. The method of claim 43, wherein the re-coater blade is a knife-edged blade having an edge apex thickness of less than 500 micrometers.

45. The method of claim 44, wherein the re-coater blade is at a tilt angle with an X-Y plane of less than 90 degrees.

46. The method of claim 38, wherein the re-coater blade is a knife-edged blade having an edge apex thickness of less than 500 micrometers.

47. The method of claim 46, wherein the re-coater blade is at a tilt angle with an X-Y plane of less than 90 degrees.
